(19) United States
(12) Patent Application Publication
(10) Pub. No.: US 2005/0256744 A1
(43) Pub. Date: Nov. 17, 2005

(54) System for accessing employee-related occupational healthcare information

(76) Inventors: Ulf Rohde, Houston, TX (US); Bruce Meymand, Houston, TX (US)

Correspondence Address: Alan R. Thiele;Strasburger & Price, LLP, 901 Main St., Suite 4300, Dallas, TX, 75202, US

(21) Appl. No.: 11/129,186

(22) Filed: May 13, 2005

Related U.S. Application Data
(60) Provisional application No. 60/570,859, filed on May 13, 2004.

(51) Int. Cl. G06F 17/60

(52) U.S. Cl. 705/2

(57) ABSTRACT

A system for providing patient-employee related healthcare information in a secure environment and inputting such information according to an employer designated protocol. Once the patient-employee has been evaluated and treated by an industrial/occupational healthcare specialist, information concerning the evaluation and treatment is forwarded to a secure data storage facility. Access to the healthcare information in the secure data storage facility is granted only to those approved by the administrator of the disclosed system.

This application claims the benefit of Provisional U.S. Patent Application No. 60/570,859 filed May 13, 2004.

### FIELD

The present invention pertains to the reporting and sharing of industrial/occupational-related health information by physicians, patients, employers, insurance companies, claims administrators and all others involved in the treatment, tracking, management, and payment for industrial/occupational-related health services rendered to prospective employees, active employees, and former employees.

### BACKGROUND

The medical specialty of industrial/occupational medicine has grown out of the continuing and growing need for employers to evaluate, understand and manage the health status of prospective employees, active employees, and former employees. Health-related issues have an impact on the fitness of candidates for employment to do the jobs for which they are hired, the ability of active employees to perform the tasks associated with a designated job and the ongoing obligation of employers to supply healthcare to active employees who can no longer work—possibly because of a job-related injury. In addition, employers also: a) ask for various types of pre-employment procedures and drug screens of prospective employees, b) seek medical evaluations of injured employees shortly after an injury, and c) perform periodic random drug screens of certain categories of employees such as vehicle operators.

As the health status of candidates for employment, active employees, and former employees becomes a greater concern for human resource professionals, there is a greater need for interaction between healthcare providers and the human resource professionals that both monitor employee health and manage the heath care provided to former employees. Such interaction between the healthcare providers and the human resource professionals who must evaluate, understand and manage healthcare may also include monitoring other related concerns such as determining when an employee arrived at the office of a healthcare provider for a post-injury evaluation and when the employee departed the office of the healthcare provider. Since many job-related injuries require some sort of physical therapy paid for by the employer, the employer is often interested in both the progress of the physical therapy and the time the employee actually spent in the care of a physical therapist. Such information allows the employer to determine both if an employee is taking advantage of an injury to gain additional time away from the job and to evaluate the efficiency of the health provider and the healthcare provider's staff in minimizing the time that an individual employee is away from the job site.

Because most employers cannot afford to retain a medical doctor, a nurse, or medical technicians on staff on a full-time basis or at a job site to perform routine tasks such as medical evaluations of injured employees, pre-employment procedures, or random drug screens, such health-related services are typically provided to employers on an as-needed basis by industrial/occupational healthcare specialists.

Complicating any situation in the U.S. regarding industrial/occupational health issues is the fact that health insurance providers either reimburse employers for employee healthcare or pay industrial/occupational healthcare specialists for health-related services rendered to employees. Further complicating the process of obtaining payment or reimbursement from health insurance providers is the use of professional claims administrators. These professional claims administrators act as a go-between between the employer and the health insurance provider to both monitor and facilitate the processing of claims made for the cost of services provided by industrial/occupational healthcare specialists. Still further complicating the system for providing and paying for industrial/occupational healthcare are the governmental agency regulations and forms which must be used.

Until recently, the medical evaluation forms and the standard forms reporting either a temporary disability or a medical condition evaluation as well the standard forms needed to document a permanent disability were filled out manually by industrial/occupational healthcare specialists. Staff personnel in the offices of the industrial/occupational healthcare specialists would then send the needed medical evaluations along with the required standard forms to a variety of different recipients, typically by fax. Communication by fax was used because of the need for a certifying signature of a medical doctor on the required forms and the continuing demand for rapid processing of claims for industrial/occupational healthcare related services.

Unfortunately, transmission of signed medical evaluations and standard reporting forms by fax presented its own array of problems. For example, fax transmissions may either be missing a page or include an unreadable page. This problem of a missing page or an unreadable page in a fax message generally triggers a phone call to the offices of the industrial/occupational health service specialist requesting that the fax transmission be re-sent.

As use of the Internet for transmission of information has increased, some businesses have abandoned the use of fax transmission to send documents in favor of sending copies of documents as images attached to an e-mail message. While such transmission of documents over the Internet as images attached to e-mail messages has speeded up communication, the use of e-mail to transmit private medical information raises healthcare information security concerns, particularly under HIPAA guidelines. Because e-mail messages can easily be intercepted and thereby made accessible to those without a proper need to know sensitive medical information, healthcare providers may find themselves exposed to potential liability for not properly safeguarding sensitive patient-employee related medical information transmitted over the Internet.

One approach to solving the problem of providing needed industrial/occupational health related information to physicians, patients, employers, insurance companies, and other entities involved in the treatment, tracking, or payment of medical services is described in Published U.S. Patent Application No. 2002/0138306-A1. In published U.S. Patent Application No. 2002/0138306-A1, a third-party gatekeeper controls access to all needed patient-employee medical information. The third-party gatekeeper effectively charges a toll to all users needing access to patient-employee information. In addition, Published U.S. Patent Application No. 2002/0138306 A1 teaches controlling information flow by requiring hardware and software compatibility by users to enter and remove information from the third-party gatekeeper's database, which hardware and software compatibility is provided at a cost to the user by the third-party gatekeeper. Since those users presently requiring better access to industrial/occupational healthcare information already own and are using sophisticated hardware and software systems, the need remains to provide users free and easy access to needed patient-employee information using existing hardware and software systems and without the need for users to buy new or different hardware or software systems or to pay a toll to a third-party gatekeeper to gain access to relevant industrial/occupational healthcare information.

Accordingly, there remains a need in the art for secure, rapid transmission of sensitive patient-employee industrial/occupational-related health information without the need to add special hardware or software to all those who might need access to such industrial/occupational health-related information or to pay a toll to gain access to such information.

### SUMMARY

The system of the present invention provides rapid transmission of sensitive patient-employee industrial/occupational health information to all those who might need access to such information in a secure environment without the need to add special hardware or software systems or to pay a toll to gain access to needed information.

In the practice of industrial/occupational healthcare, a patient, typically a prospective employee, an active employee, or a former employee, will be sent to an industrial/occupational healthcare medical center by an employer for performance of one or more of a variety of different health-related evaluations or treatments. Once medical personnel at the industrial/occupational healthcare medical center have performed the prescribed evaluation or treatment according to protocols established by the patient-employee's employer, one or more status reports are prepared. The accuracy of the status reports is certified by a medical doctor by affixing a signature. According to the present invention, the status reports, in electronic form, along with the certifying signature of the medical doctor, also in electronic form, are then sent to a secure electronic data storage facility. Access to individual patient-employee medical records in the secure electronic data storage facility is limited to a controlled list of users whose identity is verified before access to the secure electronic data storage facility is provided.

Once the properly verified status reports have been sent to the secure electronic data storage facility, the reports become accessible to those in need of the reports. Accessibility to the electronic data storage facility is facilitated by commonly available software, thus obviating the need for users to buy special equipment or upgrade computer equipment already in place. This accessibility to patient-employee medical records is obtained either by use of a hyper-link on a notice message or by addressing an e-mail message directly to the secure electronic data storage facility. Security of patient information is controlled by requiring those in need of the reports to complete one or more items of qualifying information such as a user ID and a password.

### BRIEF DESCRIPTION OF THE DRAWING FIGURES

A still better understanding of the disclosed system for accessing employee-related healthcare information may be had by reference to the drawing figures, wherein:

FIG. 1 is a schematic overview of the disclosed system;

FIG. 2 is a sample of an employer protocol;

FIG. 3 is a sample Worker's Compensation status form for the State of Texas;

FIG. 3A is a sample Report of Medical Evaluation for the State of Texas;

FIG. 4 is an example of a portal screen for gaining access to the disclosed system;

FIG. 4A is a sample list of employers;

FIGS. 5, 5A, 5B, 5C, 5D, 5E, and 5F are an example of the account setup pages for an individual employer;

FIG. 6 is a sample employer home page;

FIGS. 7 and 7A are an example of billing information pages associated with an individual employer;

FIG. 8 is a sample chronological record of treatment for several employees;

FIG. 9 is an example of a request for a drug screen;

FIG. 10 is a sample of a drug test request;

FIG. 11 is an example of post-drug test information;

FIG. 12 is a sample of a drug test results screen;

FIG. 13 is an example of a new incident record;

FIG. 13A is a sample of an initial status report;

FIG. 14 is an example of an e-mail notification;

FIG. 15 is a sample of a Physical Therapy Initial Evaluation form;

FIG. 16 is an example of a Physical Therapy Initial Evaluation report;

FIG. 17 is a sample of a Physical Therapy Daily Note;

FIG. 18 is an example of a Physical Therapy Daily Note report; and

FIG. 19 is a sample of an Occupational Therapy Discharge.

### DESCRIPTION OF THE EMBODIMENTS

Overview

The disclosed software system enables the operation of a web-based occupational medical database system which is controlled by the industrial/occupational health services specialist to accomplish the following functions:
a) Simultaneously directing and updating, in real time, employer industrial/occupational healthcare examination or treatment protocols for use by multiple medical facilities that provide industrial/occupational health services for prospective employees, active employees, and former employees of employers who have retained the services of industrial/occupational healthcare specialists using the disclosed software system.
b) Simultaneous, real-time reporting of workers' compensation medical treatment information, with or without patient-employee identifying information, to multiple users of this information, including, but not limited to, local and remote offices of employers, third-party claims administrators, government agencies, insurance companies, and professional employer organizations.
c) Simultaneous and real-time reporting of pre-employment medical information to multiple users of this information, including, but not limited to, local and remote offices of employers, third-party claims administrators, and professional employer organizations.
d) Maintaining electronic medical records for employers and others having a need for those medical records for an indefinite period of time.

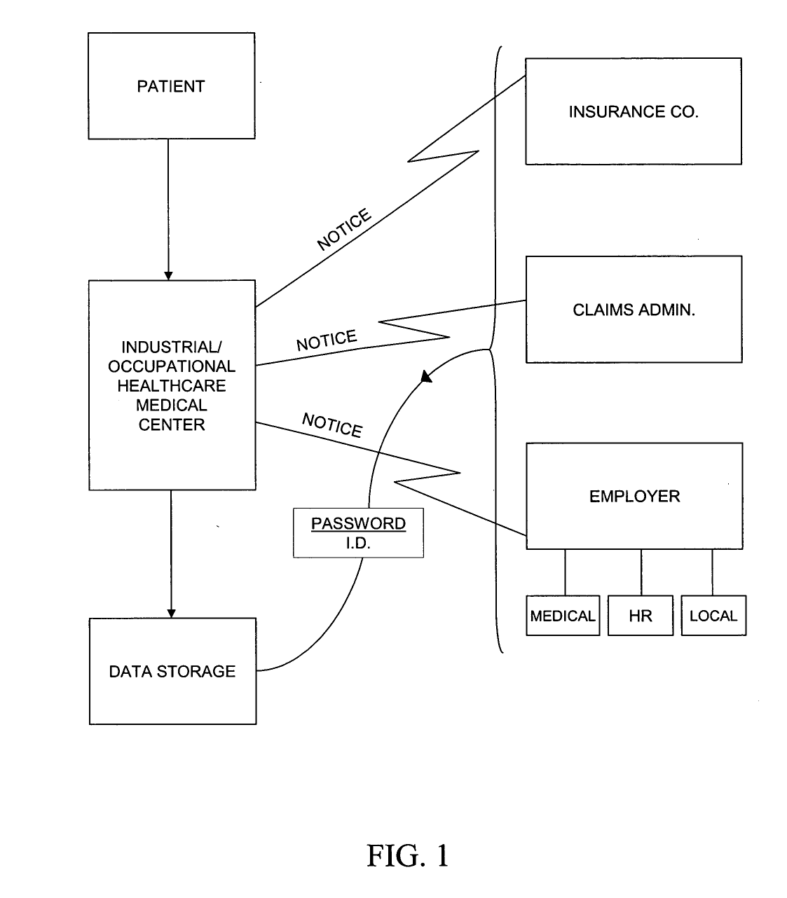

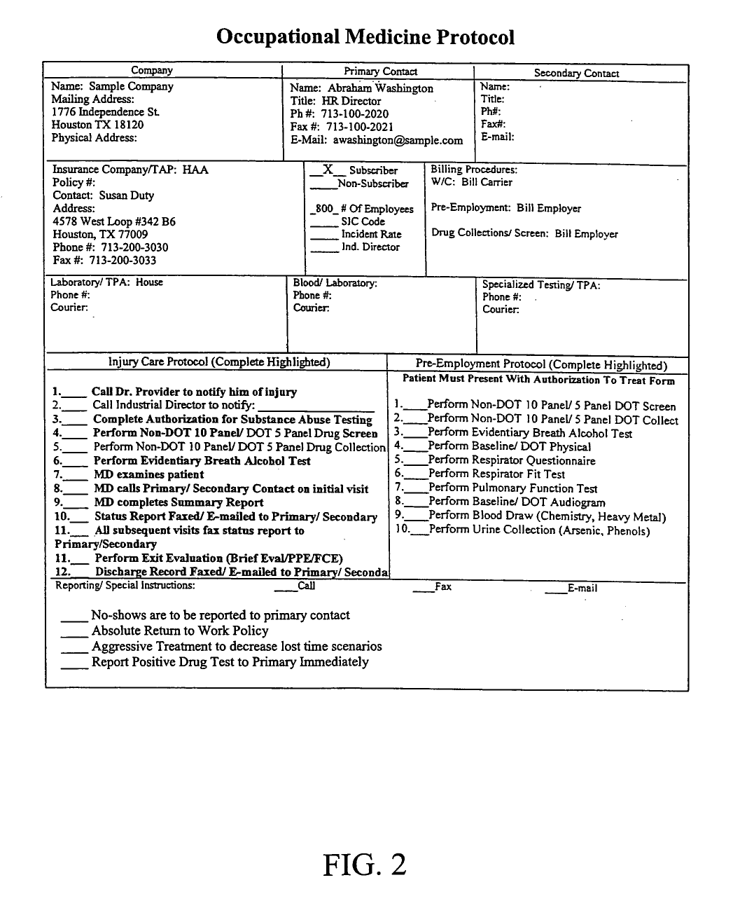

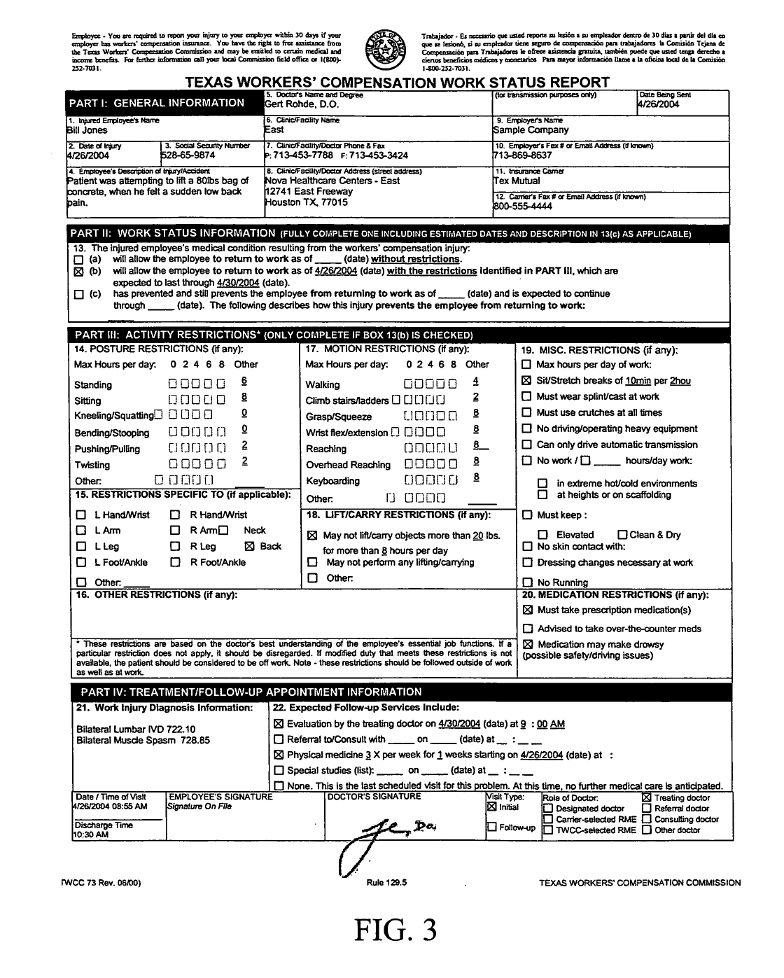

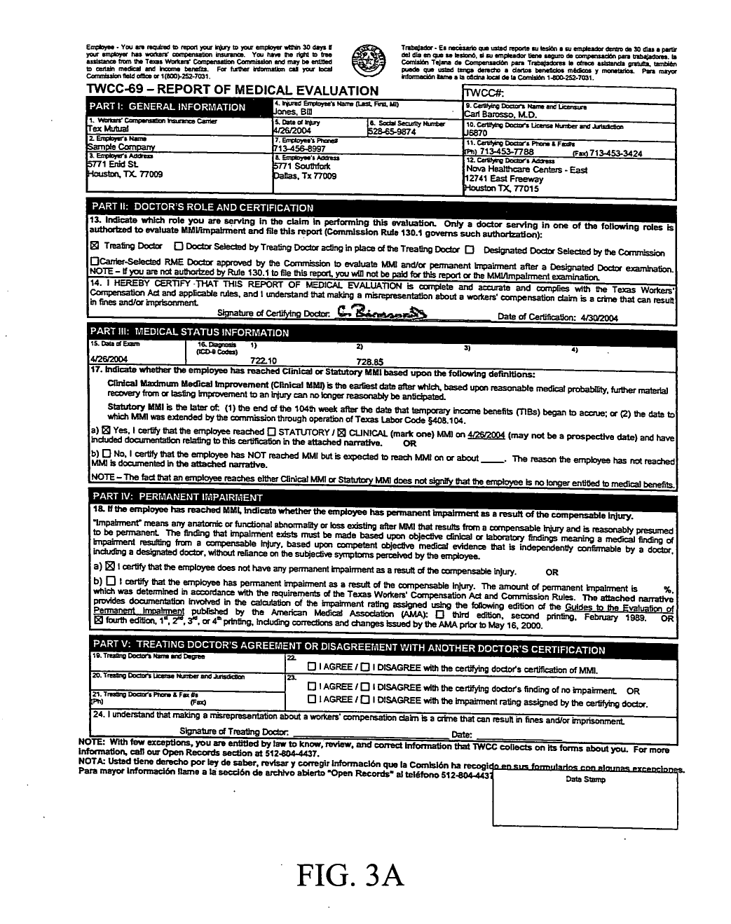

An overview of the disclosed system appears at FIG. 1. The industrial/occupational health service specialist and the administrative team at the industrial/occupational healthcare medical center generate all required information for patient-employees of employers and enter information into the disclosed system. The generated information is transmitted electronically to a secure electronic data storage facility in a format required by either government regulation or according to a protocol specified by an individual employer. An example of an employer protocol appears at FIG. 2. Sample government agency forms appear at FIGS. 3 and 3A.

The secure electronic data storage facility shown in FIG. 1 houses the macro database that contains all patient-employee medical information for all employers using the services of the industrial/occupational health service specialist administering the disclosed system. Within the macro database are sub-databases which contain only the medical records of an individual employer's patient-employees.

Industrial/occupational health services professionals enter information into the sub-database for a particular employer by responding to various prompts requesting specific items of employer-designated personal information. Information regarding a particular patient-employee becomes a record under the employer's sub-database. If a patient-employee is involved in multiple injuries, the record of the health services provided for each injury becomes a separate sub-record. Access to these injury-related sub-records is achieved by a link to each particular injury.

Operation

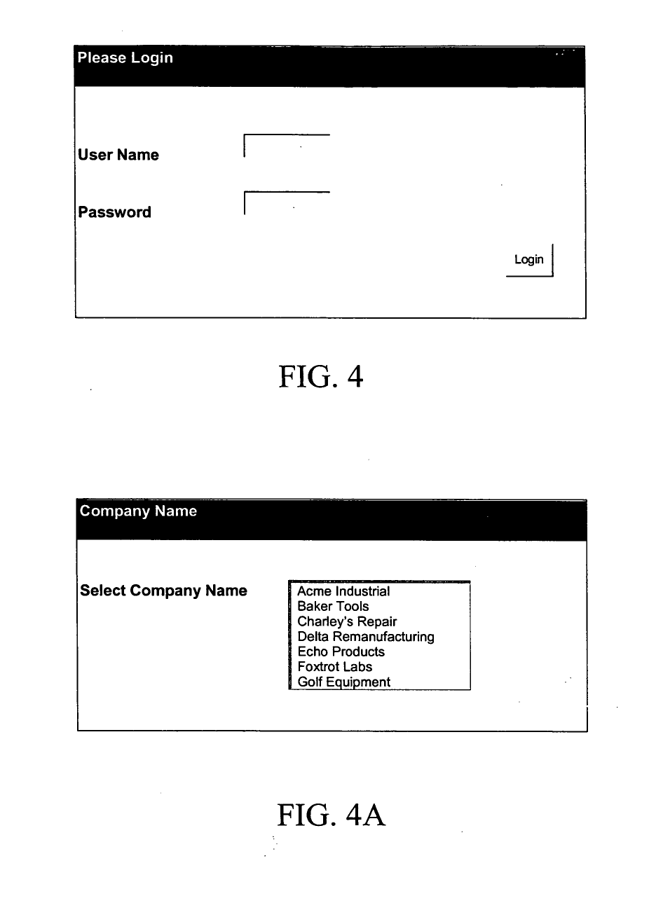

Industrial/occupation health service specialists and/or their staff, employers of patient-employees, third-party administrators, and insurance companies may obtain access to the secure electronic data storage facility which contains a database of patient-employee medical information. Such access is gained through an encrypted secure socket layer web portal by entering a user name and a password on a screen such as shown in FIG. 4. Proper recognition of an authorized user will produce a list of employers using the industrial/occupational health services specialist administering the disclosed system, as shown in FIG. 4A. The user simply selects the employer to gain access to the desired information.

Access to the database of medical information in the secure electronic data storage facility is granted to authorized users of the patient medical information by an administrator. The administrator is under the control of the industrial/occupational healthcare specialist using the disclosed software system.

Each staff member of the industrial/occupational healthcare specialist is tagged by a personal e-mail address to the particular facility at which healthcare is provided. This personal e-mail address is used to link to a default address and associated contact information. The default address and individual contact information are then tagged to all documentation of the industrial/occupational health services provided.

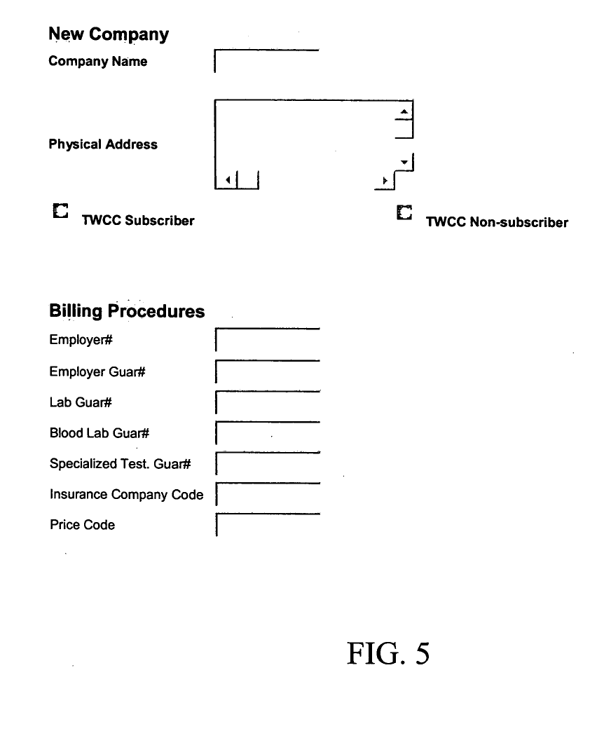

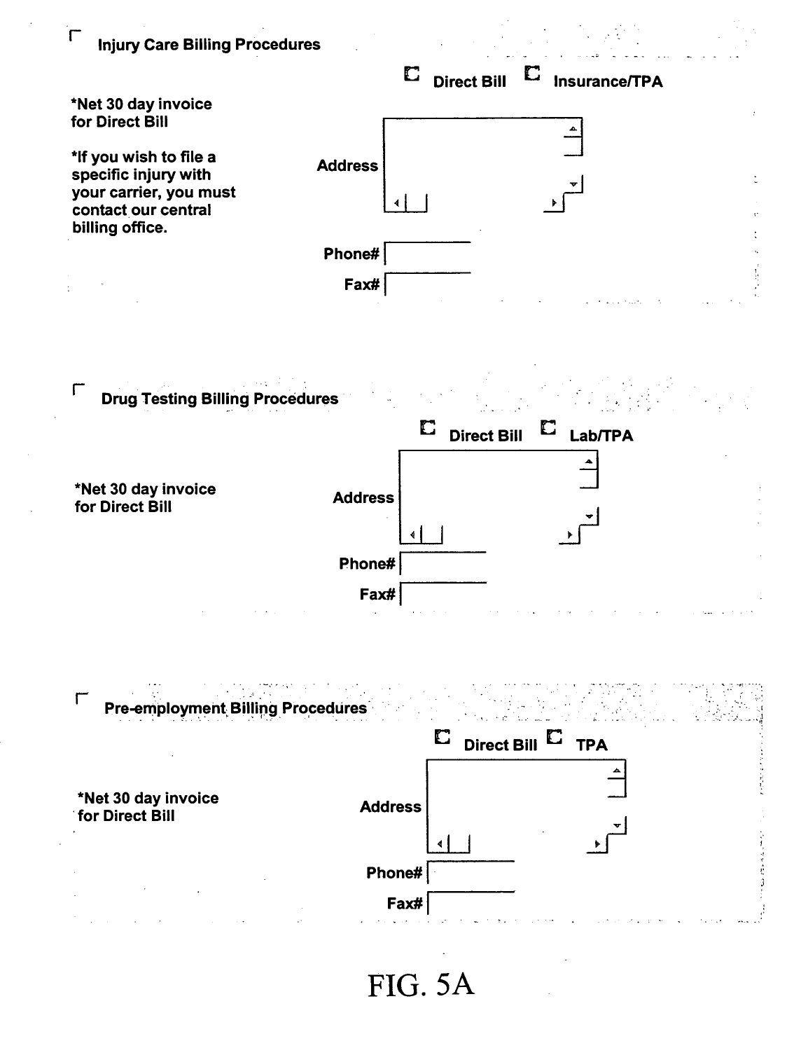

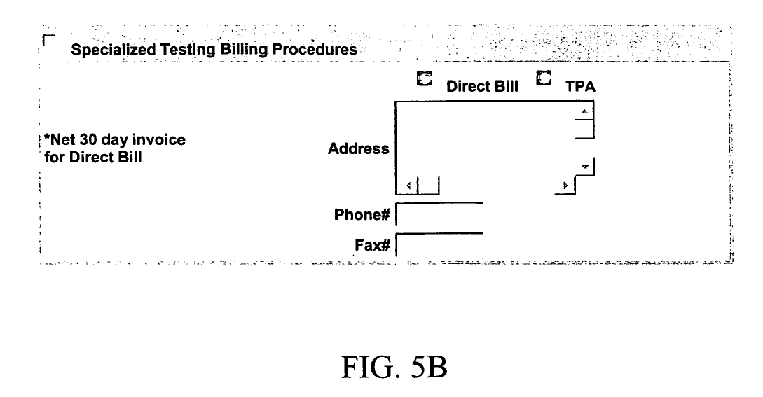

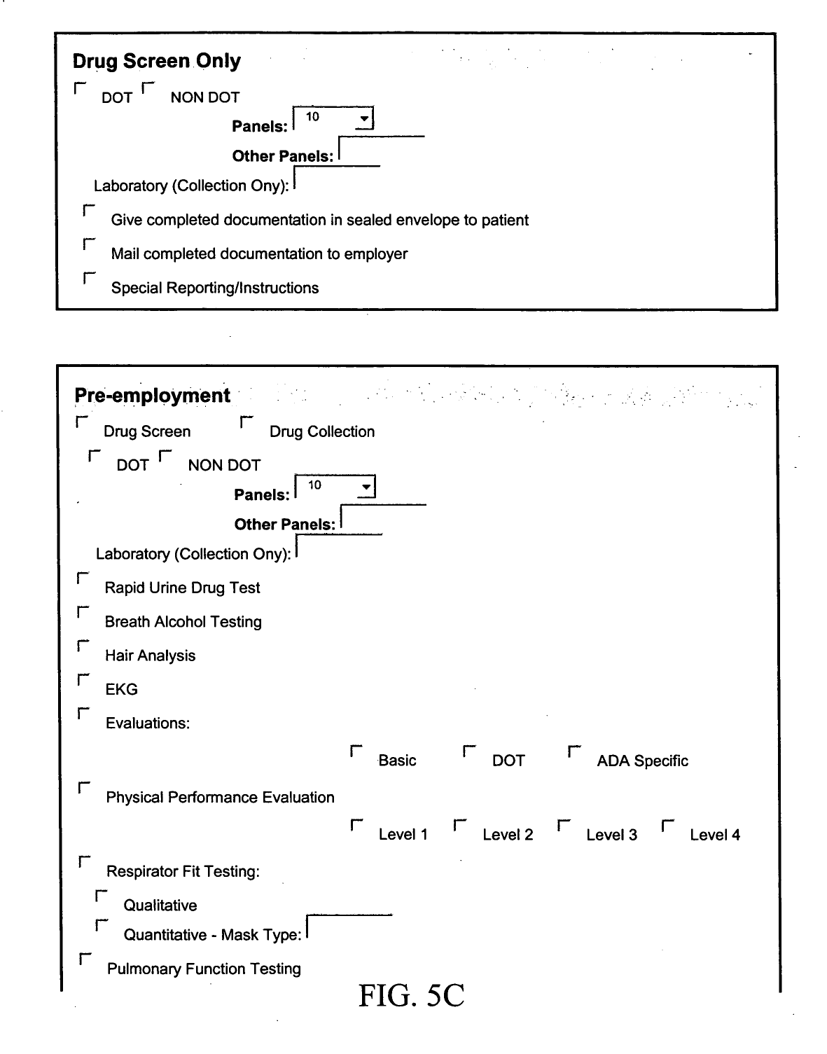

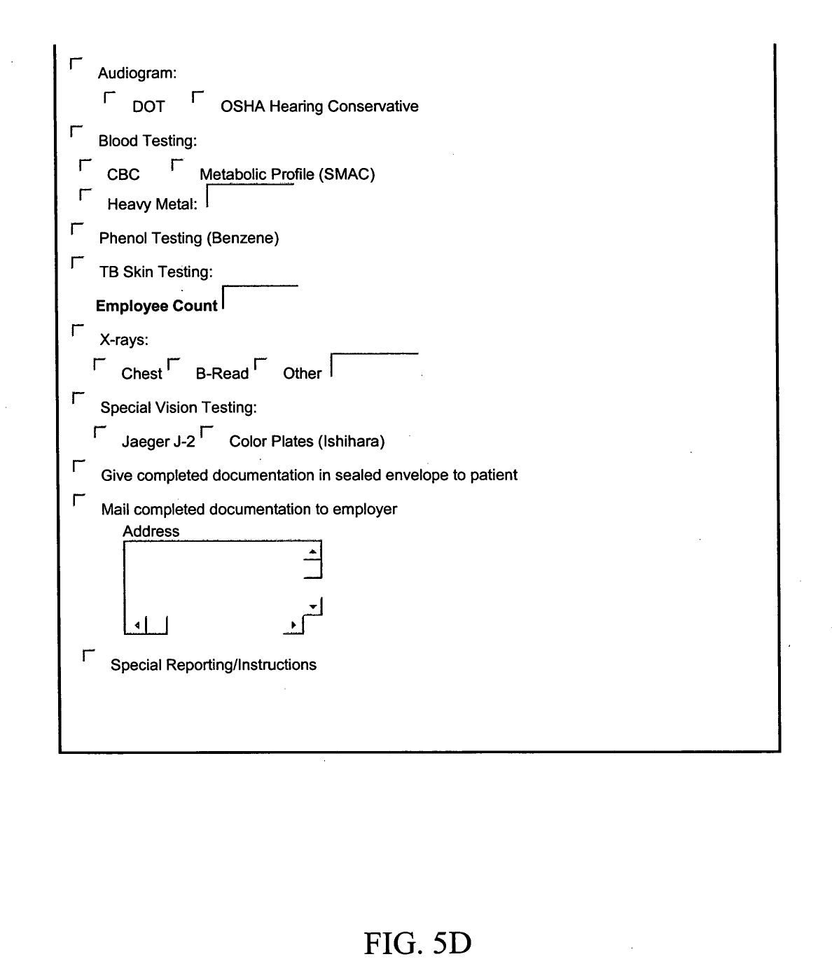

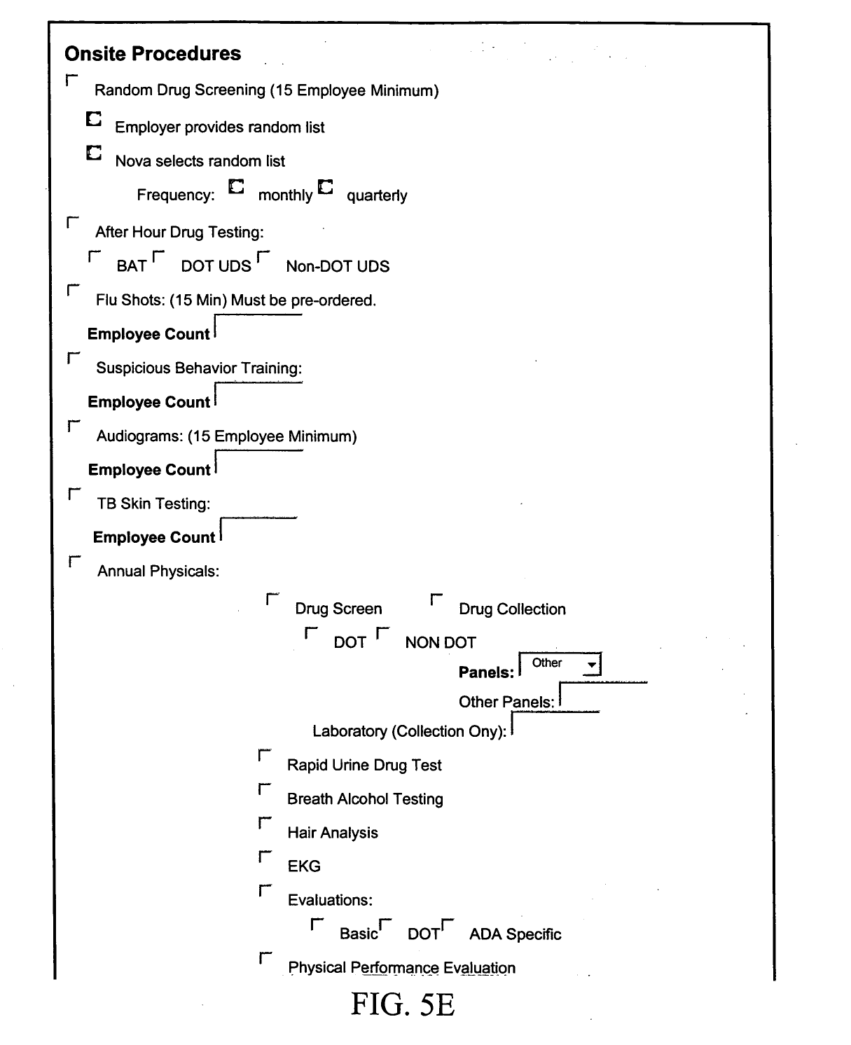

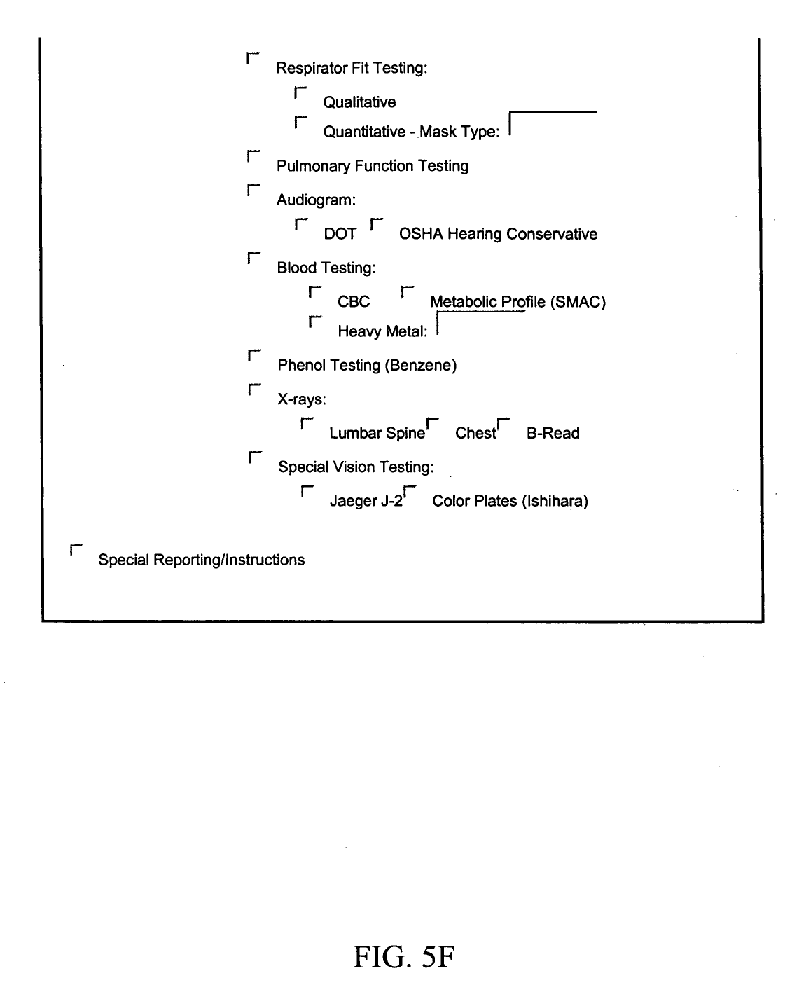

New account files for employers electing to use the services of the industrial/occupational health service specialist administering the disclosed system are added by the completion of account set-up pages shown in FIGS. 5, 5A, 5B, 5C, 5D, 5E, and 5F. Requested information includes demographic information on the employer, contact information on the employer, and any procedures specifically requested by the employer. Also included are the types of health-related services normally provided to patient-employees, including drug screens, injury care, pre-employment procedures, and periodic physical procedures such as check-ups.

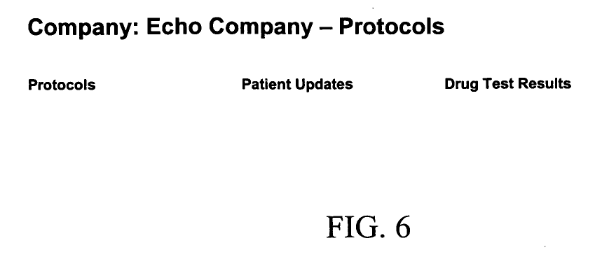

Once the account has been set up as described by completing the information shown in FIGS. 5, 5A, 5B, 5C, 5D, 5E, and 5F, an employer home page, as shown in FIG. 6, for each employer is created by the disclosed system. This employer home page provides the pathway into the sub-database which contains the medical information of an individual employer's patient-employees. The employer home page is set up for use by the providers of industrial/occupational health services, individual employers, the third-party claims administrators, and the insurance companies who may ultimately pay for the health services provided. The employer's version of the employer home page includes access to those protocols set up specifically for the individual employer, patient updates, and the results of drug testing. For the provider of industrial/occupational health services, the employer home page includes everything available to the employer as well as a link enabling entry of patient-specific information.

The employer home page which provides entry into the sub-database of an individual employer's patient-employees may also include the ability to attach various employer-specific documents, in electronic form, which are required for the execution of predetermined examination, evaluation, or reporting protocols required by the individual employer. Exemplary protocols which may be added by an individual employer include:
Drug Screen Only
Injury Care
Pre-Employment Procedures
Account Set-Up

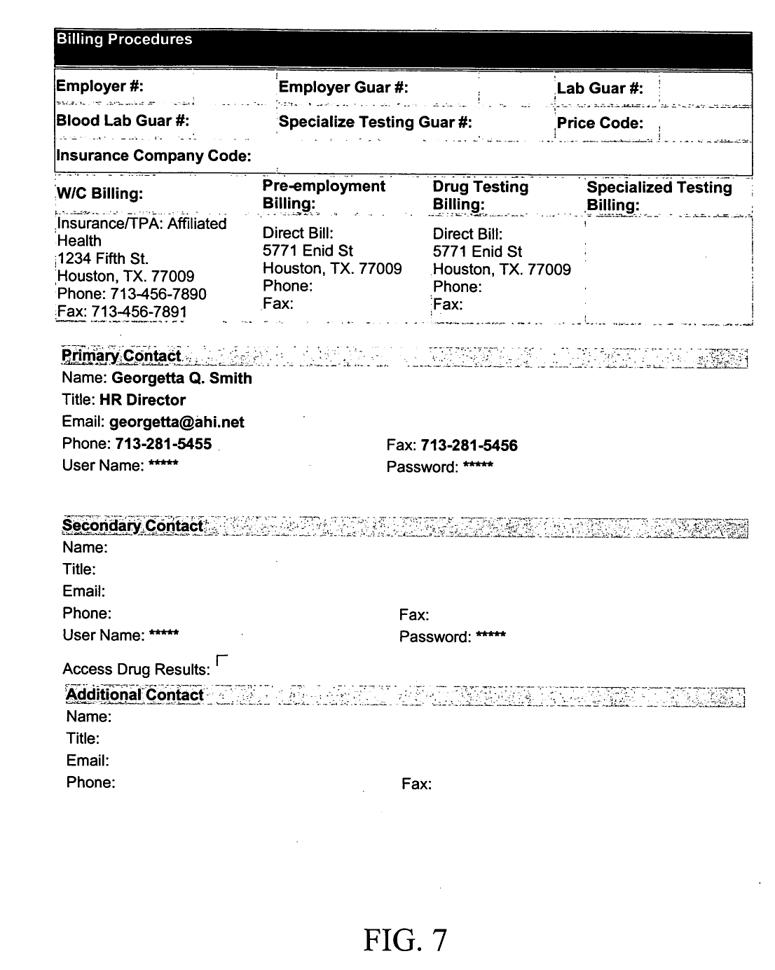

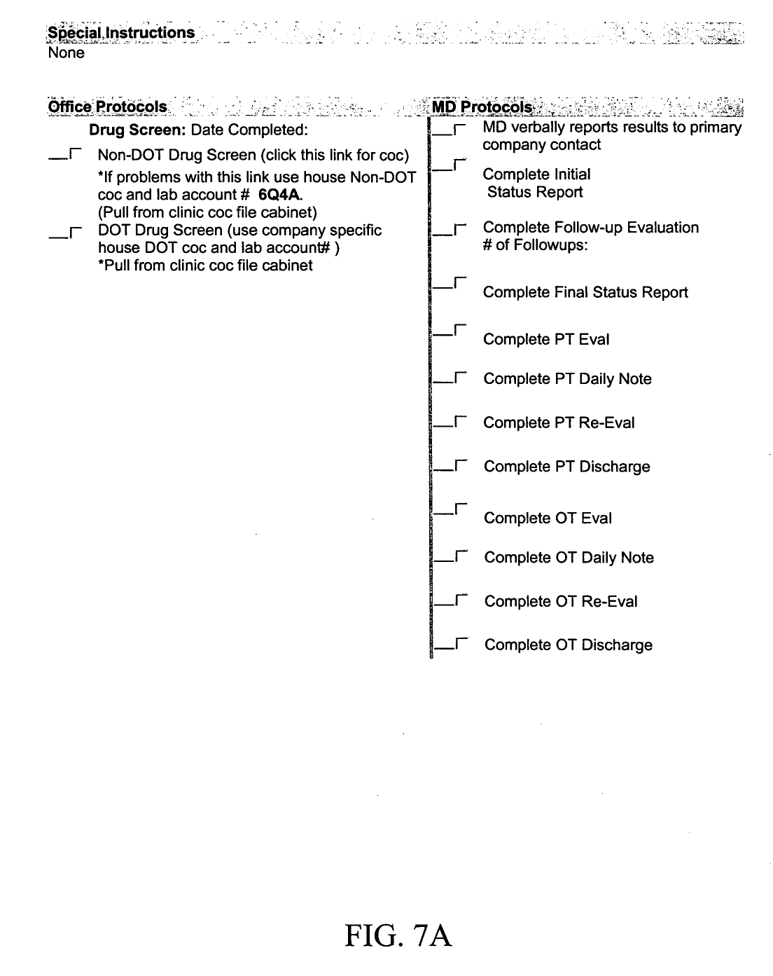

Within each of the foregoing employer-designated protocols, the user is directed to the following information, as shown in FIGS. 7 and 7A, which is specific to individual employers.
a) Billing Procedures with assigned billing codes. The billing codes are necessary to maximize both accuracy and efficiency in the billing process.
b) Designated primary, secondary, tertiary, or subject matter related contacts for a particular employer.
c) Special instructions of the individual employer.
d) Office protocols to be completed by the administrative personnel working at the industrial/occupational healthcare service medical center.
e) Medical protocols to be completed by the industrial/occupational health services specialist.

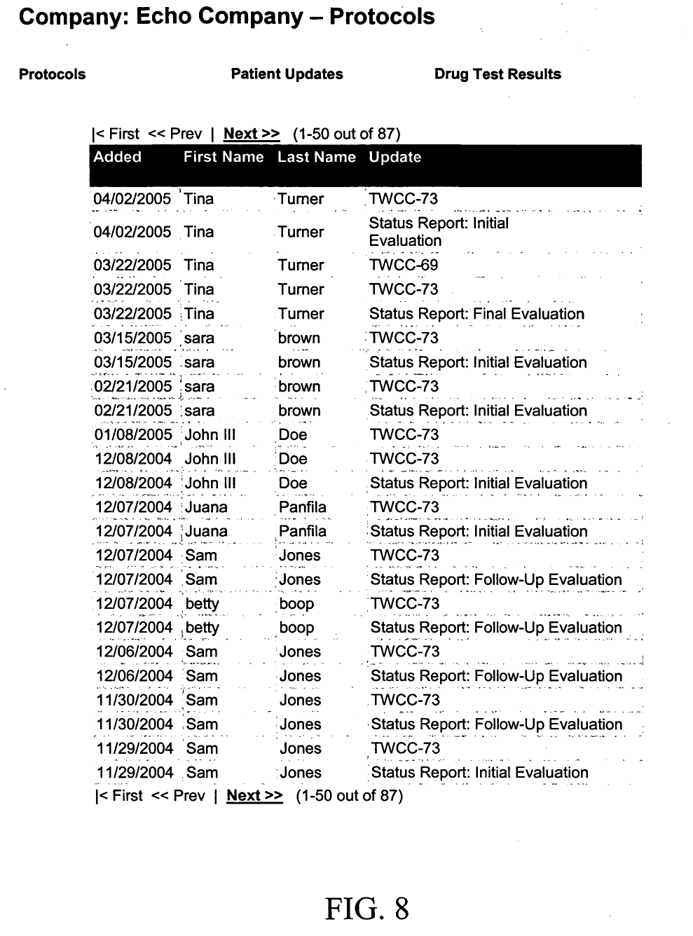

Industrial/occupational health services professionals use a link on the employer home page to gain entry to data for a particular patient-employee. Selecting this link produces a chronological listing of patient-employees for a particular employer, as shown in FIG. 8. New patient-employees are entered into the employer's sub-database based on the particular industrial/occupational health service protocol performed. The list of patient-employees can be sorted according to various criteria.

Updates for each patient-employee in the sub-database of employees for each individual employer assure a current database of completed daily worker's compensation medical status reports along with completed forms required by state agencies. Exemplary forms for the State of Texas are shown at FIGS. 3 and 3A. The most recent patient-employee reports are added and displayed at the top of the ongoing employer's sub-database list of patient-employees. Individual reports are available to authorized users by simply clicking on a link to the desired report.

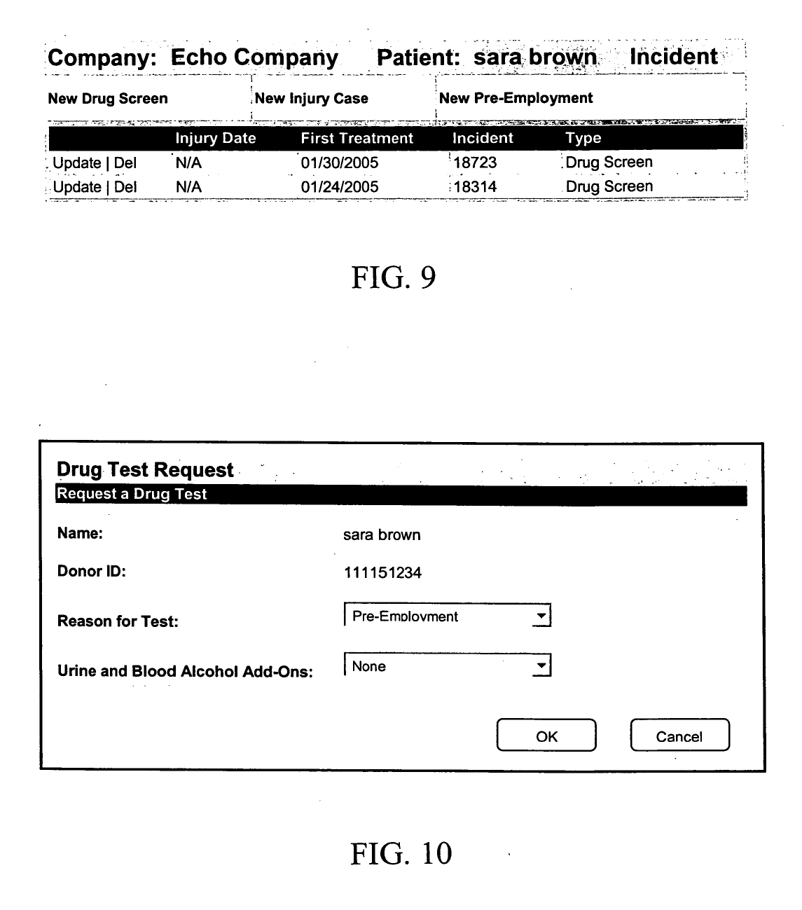

For a drug testing protocol, the industrial/occupational health services provider selects the new drug-screen protocol as a new incident record, as shown in FIG. 9, to be sent to the sub-database for an individual employer. The disclosed software system then provides the industrial/occupational healthcare specialist with a detailed drug testing protocol as established by an individual employer.

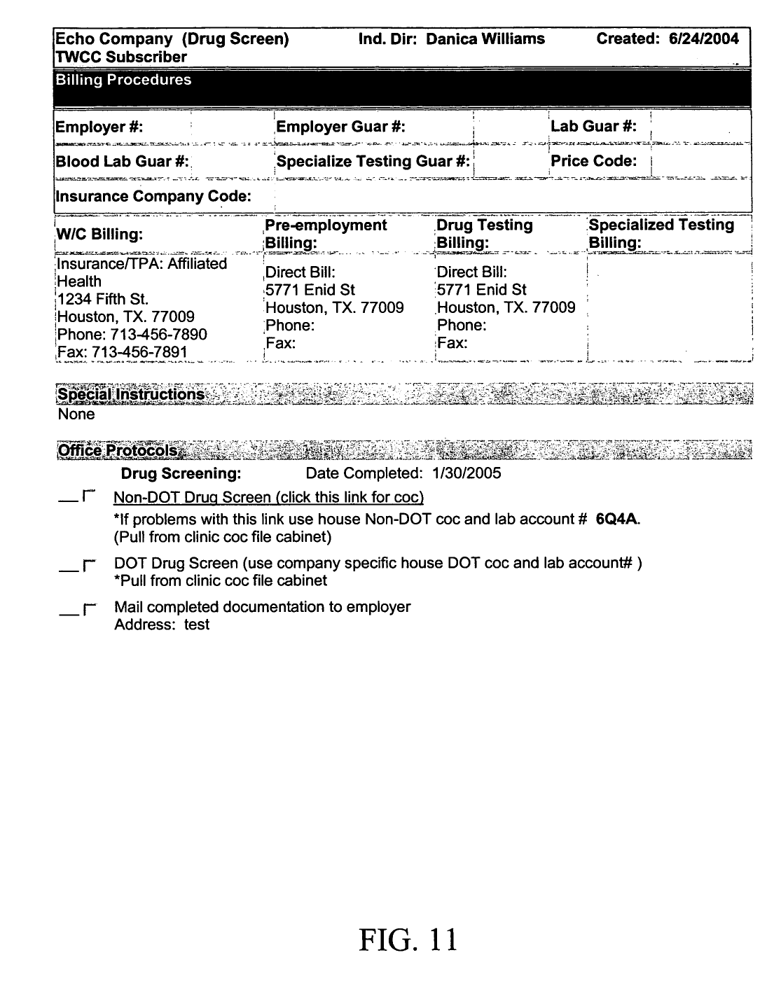

The drug testing protocol for an individual employer begins with an active link for drug testing which is not related to U.S. Department of Transportation (DOT) drug testing standards. This active link then provides the industrial/occupational health services professional with patient-employee specific information and produces the necessary chain of custody forms which, as shown in FIG. 10, accompany the submission of the drug test to the drug testing laboratory. If desired, the disclosed system provides a reminder to the industrial/occupational health services specialist to print out the chain of custody forms and to complete the required clinical procedures, as shown in FIG. 11.

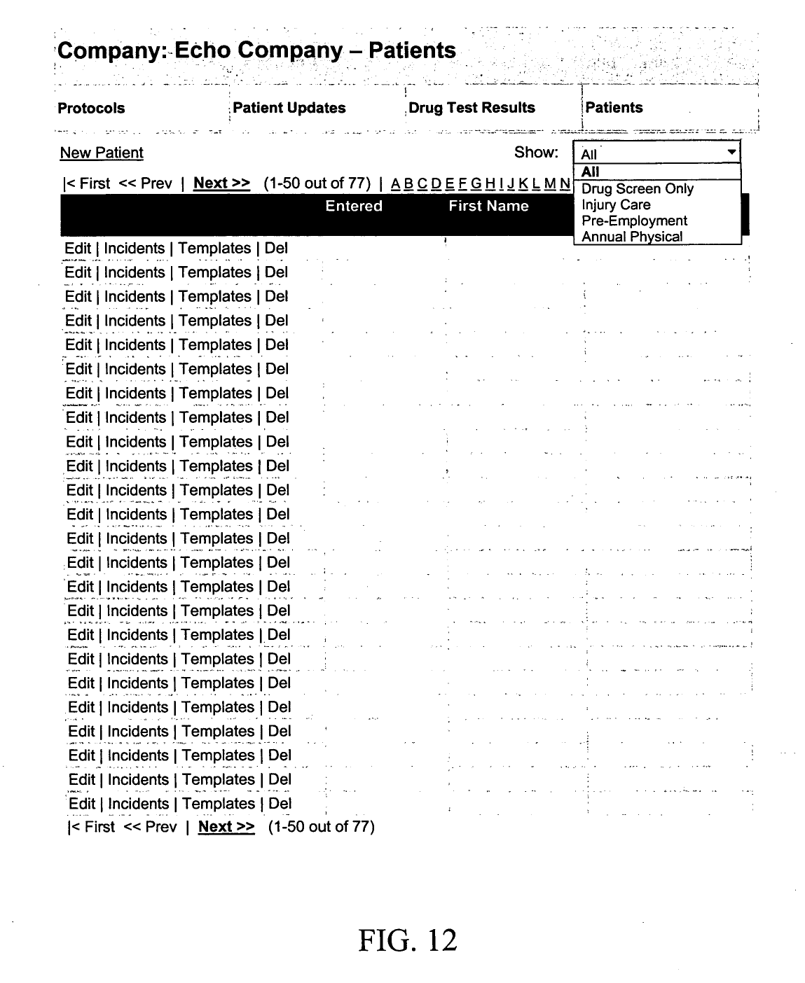

If a user of the disclosed system seeks drug test results for a particular patient-employee, the user clicks on a link to this website. Access to the drug test results website, as shown in FIG. 12, is granted by completing a set of qualifying data along with user name, a user password, and other account-specific information.

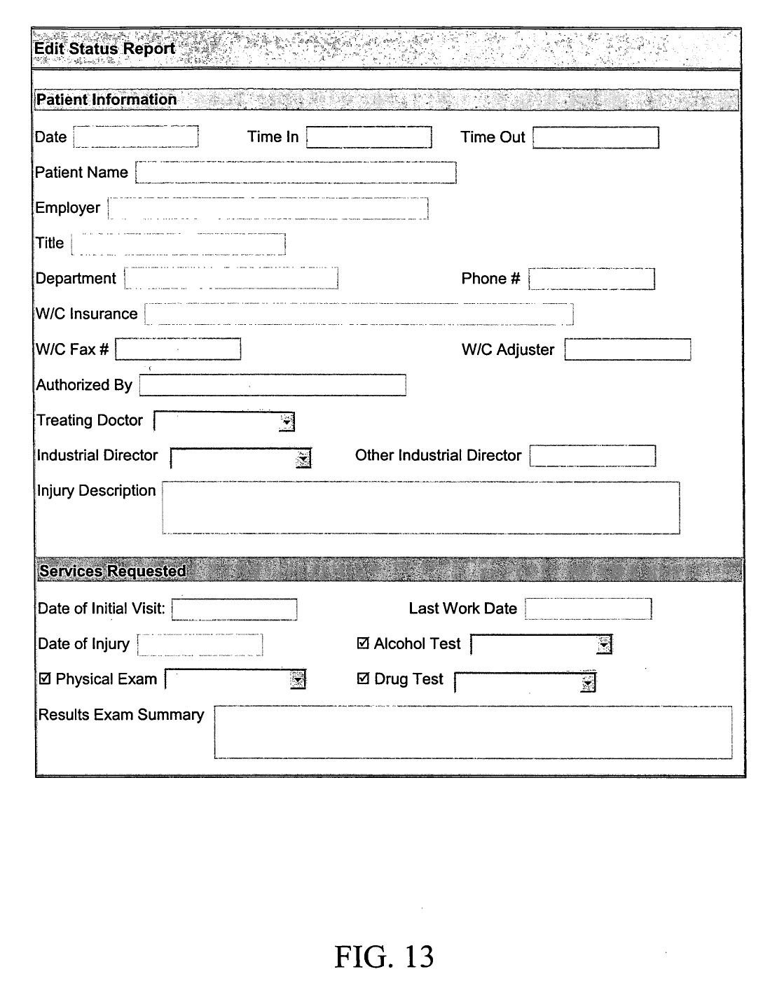

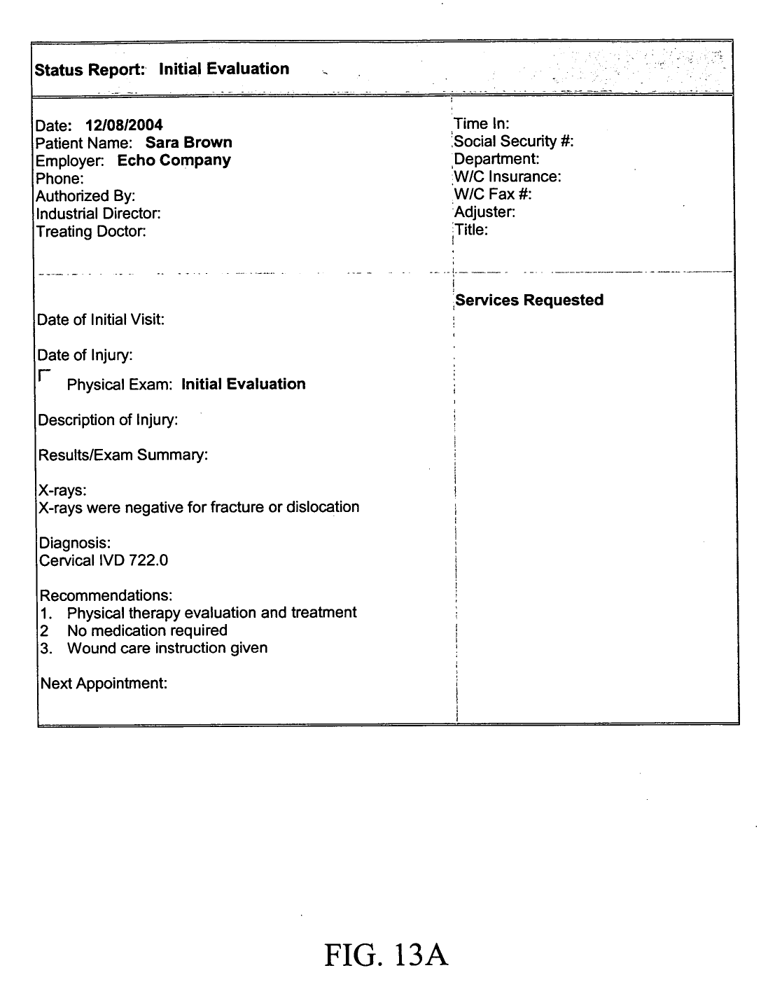

Once the industrial/occupational health service professional has gained entry to a set of databases for a particular patient-employee, the industrial/occupational health service professional has several options available, as follows:
a) creating a new incident record, as shown in FIG. 13;
b) entering the record for a previous incident by clicking on an update tab for a selected incident.

In the case of a new injury to a patient-employee, the industrial/occupational health services specialist selects the protocol for treatment of a new injury within the individual employer's sub-database. The disclosed system then provides a detailed injury care protocol based on the information provided by each individual employer.

The industrial/occupational health services specialist enters the necessary demographic information describing the new injury. Once this information has entered a patient-employee's record in the employer's sub-database, the information is saved as a separate record for continuation by another member of the industrial/occupational health services specialist team. The disclosed system will provide the industrial/occupational health services specialist team with both administrative claim-processing information as well as medical information.

The industrial/occupational health services specialist follows the protocol specified by an individual employer for treating a new injury. Prompts for the information regarding the nature of the injury and the treatment are provided so that the required information describing the injury may be quickly downloaded into an initial status report, as shown in FIG. 13A, an interim report, or a final status report in the format and at the location specified by the report. Also provided to the industrial/occupational health services provider is a status data-entry page which includes other information from previous patient-employee records or employer records. In the event that mandatory required information is not supplied, the disclosed system provides a reminder that mandatory information has not been provided to assure 100% completion of the required forms.

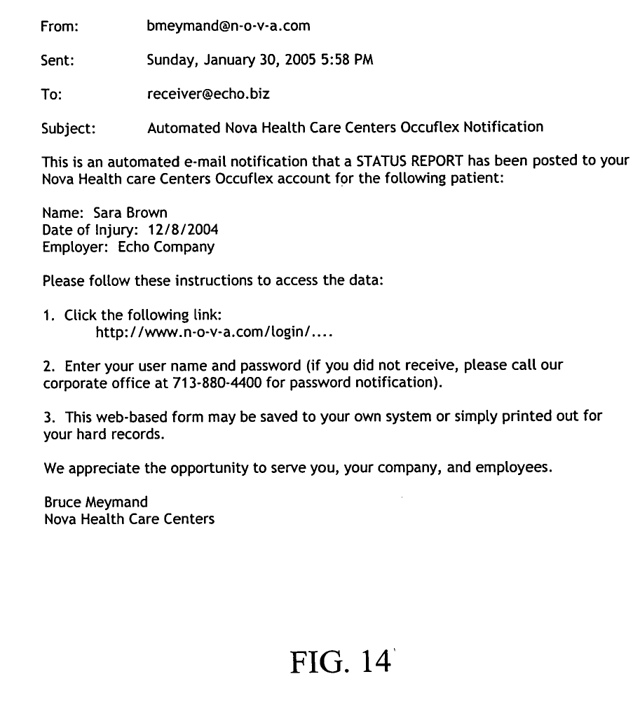

Once the status report on a particular injury to a patient-employee has been completed, the disclosed system generates a set of data, then stores the status report along with any mandatory forms or medical evaluation forms required by local law. In addition to storing the status report along with any mandatory forms or medical evaluation forms required by local law, the system automatically generates an e-mail notification, as shown in FIG. 14, to provide notification of the completion of the report and secure storage of the information describing the condition of the patient-employee to the points of contact designated by the employer.

To gain access to the stored information on a particular patient-employee, those authorized to gain access to the healthcare information for the patient-employee enter their e-mail address and select the link to the desired healthcare information on the patient-employee. The selection of the link opens a 128-bit encrypted user name and password page. Once the user name and password have been entered and verified as being accurate by the disclosed system, the user gains access to the patient-employee healthcare information. This level of security assures compliance with the federal HIPAA guidelines.

As patient-employee healthcare information is reported to one or more third parties to obtain reimbursement from healthcare insurance providers, understanding of the reporting structure for the healthcare insurance providers or the claims administrators is essential.

Accordingly, a single employer may have multiple claims administrators and adjusters managing the medical information relating to the care of patient-employees, particularly if the medical information relates to on-the-job injuries. For such on-the-job injuries, one adjuster is usually assigned to each injury. To assure proper security for patient-employee healthcare information, the disclosed system includes another layer of security which limits adjuster access to only the information relating to the specific patient-employee injury assigned to that adjuster.

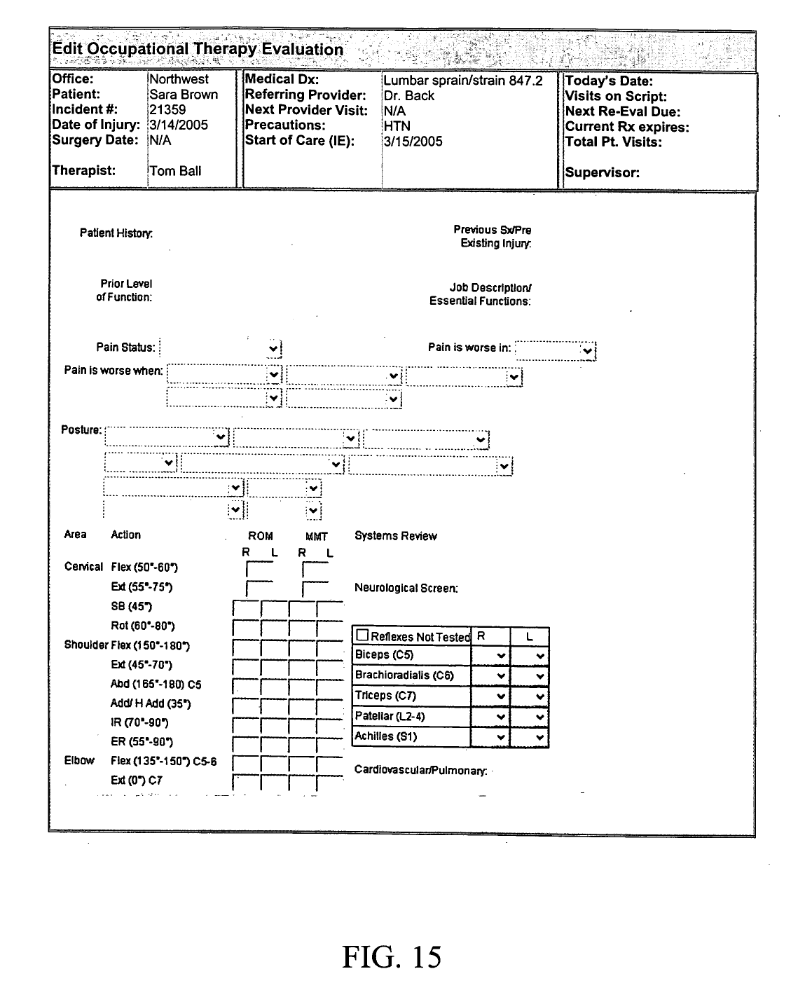

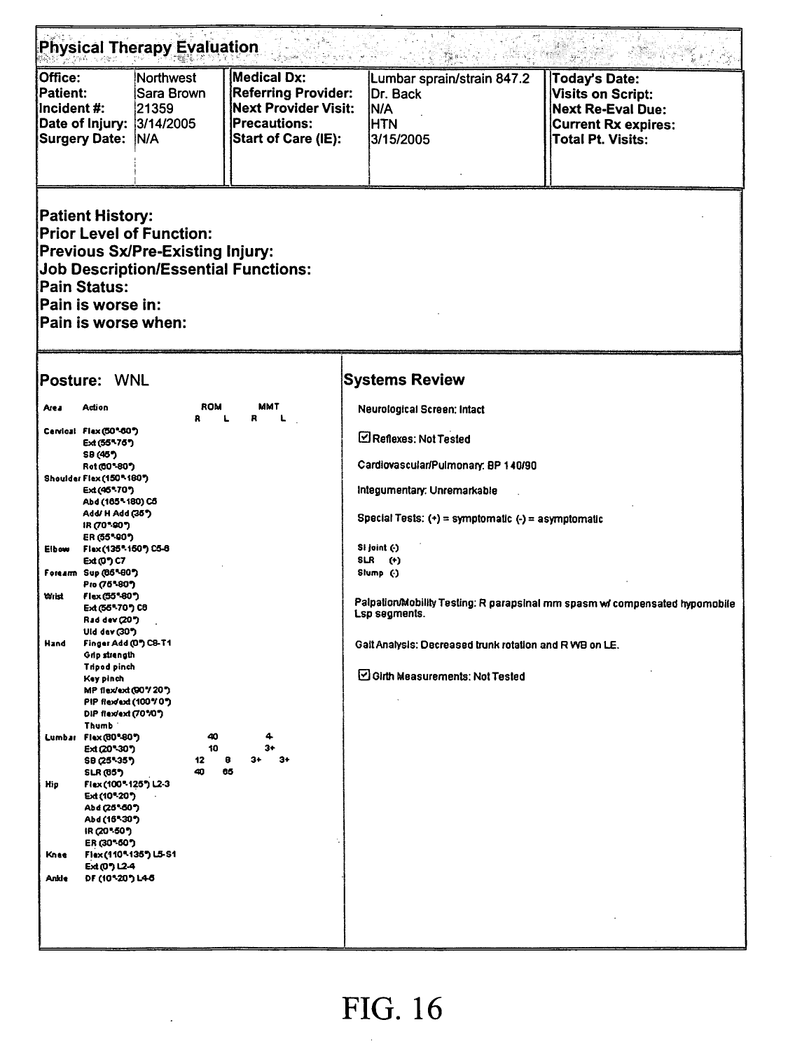

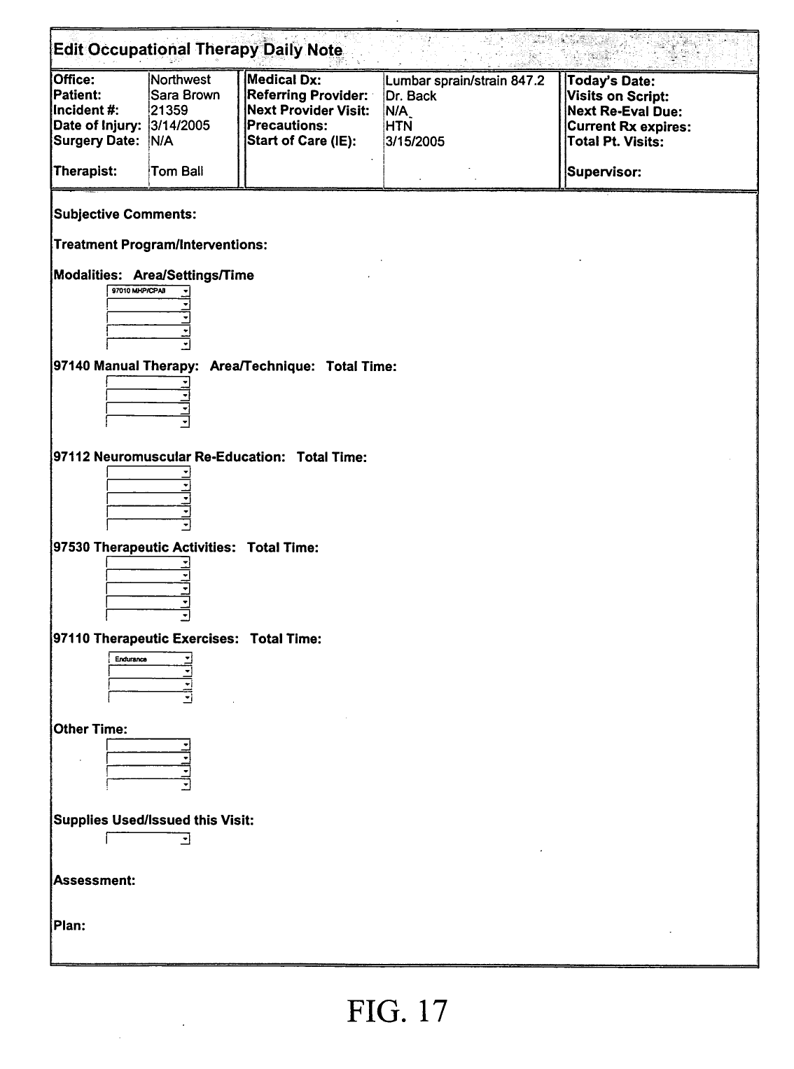

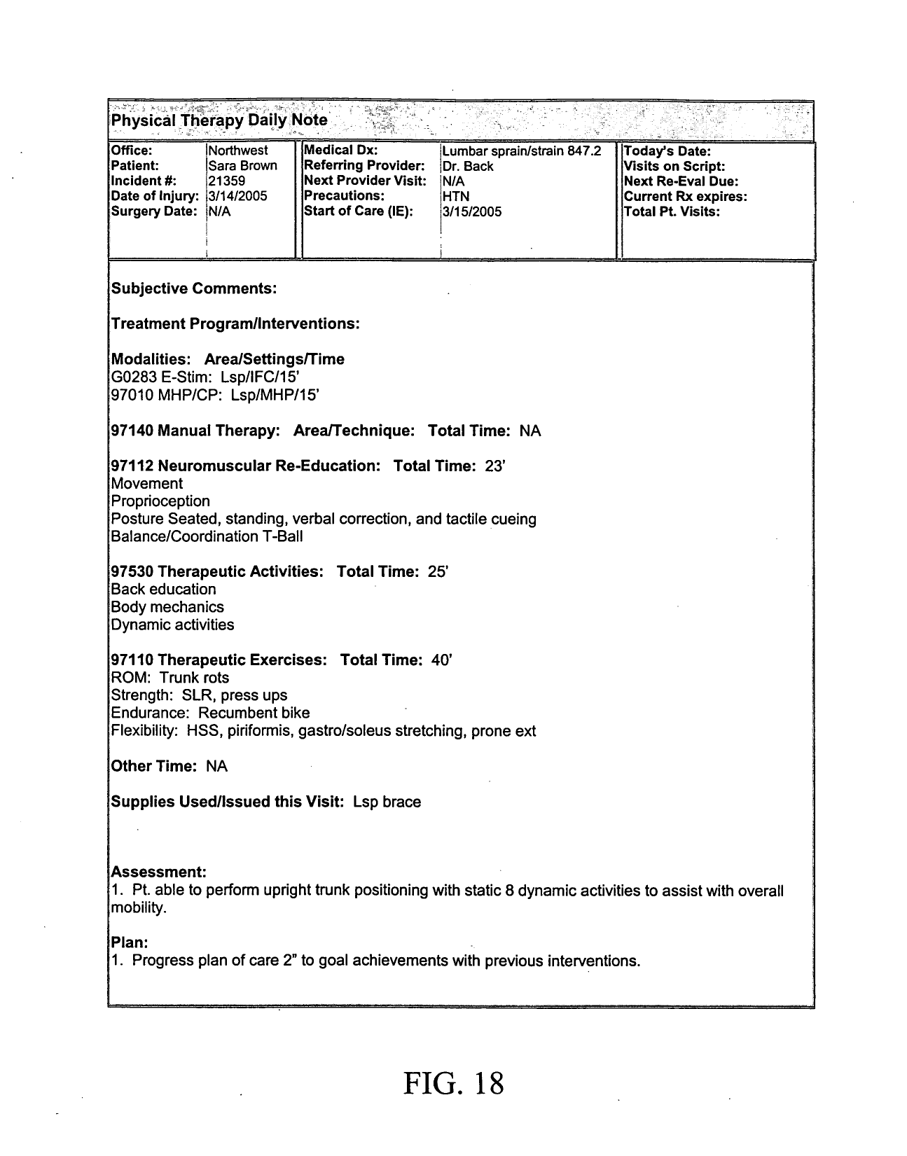

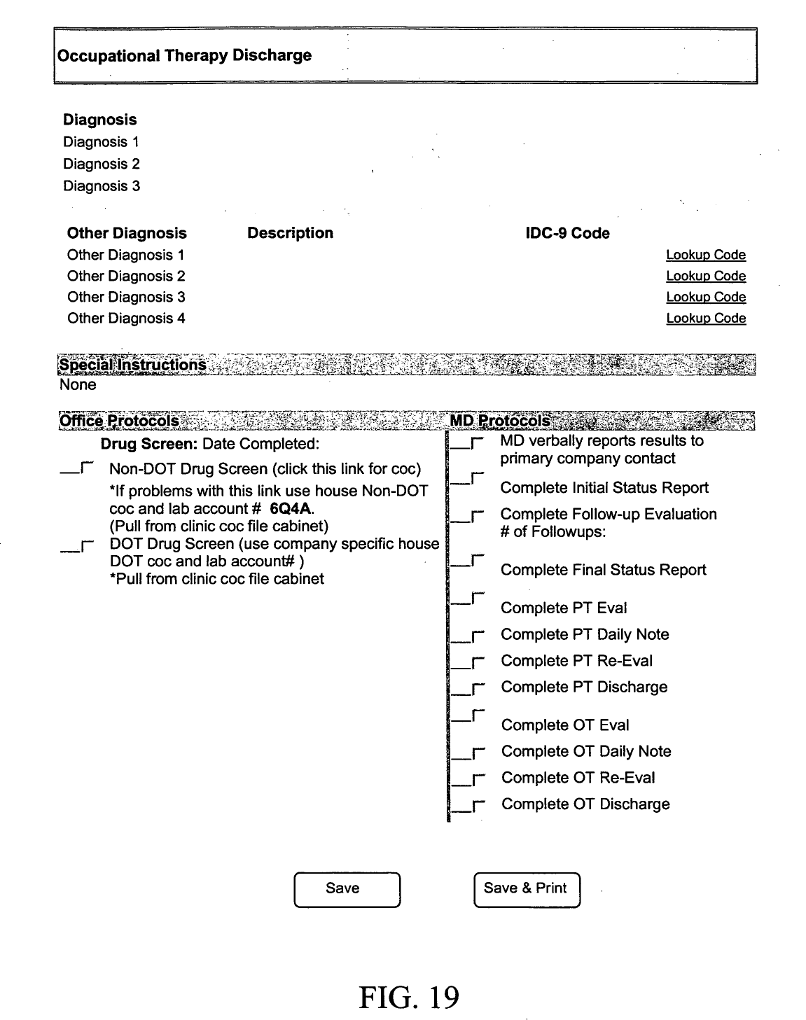

Many industrial/occupational health matters include a regimen of physical therapy to treat an injury. When physical therapy is included in the treatment plan for a patient-employee, 15, the provider of industrial/occupational health services enters specific physical therapy information for a patient-employee by selecting one of the following links:
Physical Therapy Initial Evaluation (See FIG. 15.)
Physical Therapy Initial Evaluation Report (See FIG. 16.)
Physical Therapy Re-Evaluation
Physical Therapy Daily Note (See FIG. 17.)
Physical Therapy Daily Note Report (See FIG. 18.)
Physical Therapy Discharge
Occupational Therapy Initial Evaluation (See FIG. 15.)
Occupational Therapy Initial Evaluation Report (See FIG. 16.)
Occupational Therapy Re-Evaluation
Occupational Therapy Daily Note (See FIG. 17.)
Occupational Therapy Daily Note Report (See FIG. 18.)
Occupational Therapy Discharge (See FIG. 19.)

A report on the progress of the physical therapy or occupational therapy treatment plan and the status of the patient-employee is generated by the disclosed system as previously discussed with regard to status reports for patient-employees. Once the physical therapy or occupational therapy status report is sent to storage, an e-mail notification is sent to all those authorized access to the physical therapy or occupational therapy status report.

Pre-employment procedure reporting is initiated by a user of the disclosed system selecting pre-employment procedures as a new incident within a patient-employer record in an employer sub-database. Once this link has been selected, the disclosed system provides the industrial/occupational healthcare specialist with a detailed protocol meeting the criteria of an individual employer for which the individual completing the pre-employment procedures is seeking a job. Pre-employment procedures may generate a need for one or more of the following:
Federal Department of Transportation Exams
Basic-Post Offer Exams
Respirator Fit Testing (Qualitative/Quantitative)
Pulmonary Function Testing
Physical Performance Evaluations (Levels 1, 2, and 3)
Audiograms
TB Skin Testing
X-Ray Exams (Chest, B-Reads)
Vision Testing (Wall Chart, J-2, Colors)

Those on the industrial/occupational health services team responsible for completing the pre-employment procedures will enter the needed demographic information. This demographic information is then transferred to the medical personnel responsible for completing the pre-employment procedures. The pre-employment administrative and medical protocols have been previously established when an individual employer is added to the disclosed system. Once the pre-employment procedures have been completed, the information is sent to the secure electronic data storage facility, and an e-mail notification is provided to the designated authorized users.

It is not uncommon for an industrial/occupational healthcare specialist to refer a patient-employee out to another facility for special testing (MRI, CT-scan, etc.) or to a specialist (orthopedics, neurologists, etc.) When such referral occurs there is a need to obtain a report from either the special testing facility or from the medical specialist. To meet such need, the disclosed system will receive reports from either a special testing facility or a medical specialist by e-mail, file them appropriately in a patient-employee record, and then notify designated authorized recipients that a report on a special test or from a medical specialist has been received.

The disclosed system also reports and stores data with regard to patient-employee health service information on a daily, weekly, or quarterly basis. Such data may include injury data, physical therapy data, occupational therapy data, drug-screen data, and pre-employment utilization statistics. Such data also enables the healthcare specialist to monitor business trends and activity at particular locations where healthcare services are provided to patient-employees.

Monitoring the quality of healthcare services provided to patient-employees is essential for both employers and industrial/occupational healthcare specialists. To facilitate such monitoring, the disclosed system provides reports to include data summary spreadsheets which provide a list of all patient-employees treated. Other reports may be based on either a type of injury or a particular employer location where patient-employees normally work to assist in locating heretofore unknown hazardous conditions.

Further monitoring of healthcare services provided to patient-employees includes monitoring and determining the quality of services provided by an industrial/occupational healthcare specialist. For example, the disclosed system may include capturing patient-employee sign-in and sign-out information from an electronic signature pad at a treatment facility. This information can be used to monitor if a patient-employee actually visited a healthcare facility, how long the patient-employee had to wait before receiving treatment, the time spent with the industrial/occupational healthcare specialist, and the time the patient-employee departed to return to work once having been seen at an industrial/occupational health services facility. Information from the sign-in and sign-out pads may be used to facilitate the issuance of forms requiring the signature of a patient-employee such as a DOT card or any other documentation.

Payment for healthcare service is normally requested using an invoice. In the disclosed system, the invoice may be sent electronically using e-mail. All electronic copies of invoices may be supplied to those responsible for paying for all industrial/occupational health services provided.

Those of ordinary skill in the art will realize that any type of report requested of an industrial/occupational healthcare medical center may be prepared, certified, and stored as limited-access data according to the disclosed system.

Those of ordinary skill in the art will also understand that, with needed information stored in a limited-access database, users will be able to sort, analyze, and prepare reports using the data in the limited-access database. For example, an analysis may be made of the frequency of certain types of injuries at a particular worksite.

While the disclosed system has been disclosed according to its preferred and alternate embodiments, those of ordinary skill in the art will understand that still other embodiments of the disclosed system have been enabled by the foregoing disclosure. Such other embodiments shall fall within the scope and meaning of the appended claims.

1. A system for providing patient-employee related health information in a secure environment from an industrial/occupational healthcare medical center, said system comprising:
means for requesting and arranging industrial/occupational patient-employee demographic and medical information according to a protocol specified by the employer of the patient-employee;
means for recording and certifying said industrial/occupational patient-employee demographic and medical information in a format specified by the employer of the patient-employee;
means for electronically transmitting said recorded industrial/occupational patient-employee demographic and medical information to a database in a secure electronic data storage facility;
means for prohibiting all those, except those who have the proper authorization, from gaining access to said database in said electronic data storage facility;
whereby needed items of said industrial/occupational patient-related demographic and medical information are provided to those who have authorization to gain access to said electronic data storage location.

2. The system as defined in claim 1 wherein said recorded industrial/occupational patient-employee demographic and medical information further includes an electronically transmissible certifying signature.

3. The system as defined in claim 2 wherein said recorded industrial/occupational patient-employee demographic and medical information and said certifying signature are recorded in a format required by a governmental regulatory agency.

4. The system as defined in claim 1 wherein said protocol specified by an employer is selected from a group including: pre-employment procedures, injury evaluation, injury treatment, and drug screens.

5. The system as defined in claim 1 wherein said database in said secure electronic data storage facility is divided into employer sub-databases.

6. The system as defined in claim 5 wherein personnel from the industrial/occupational medical center are provided access to all employer sub-databases in said secure electronic data storage facility.

7. The system as defined in claim 5 wherein personnel outside the industrial/occupational medical center are only provided access to individual employer sub-databases in said secure electronic data storage facility.

8. The system as defined in claim 5 wherein said employer sub-databases include records for individual patient-employees.

9. The system as defined in claim 8 wherein pre-determined users are provided access only to records for individual patient-employees.

10. The system as defined in claim 8 wherein pre-determined users are provided access only to certain portions of said records for individual patient-employees.

11. A method for providing patient-employee health information from an industrial/occupational healthcare medical center in a secure environment comprising the steps of:
obtaining a protocol from an individual employer for obtaining and reporting demographic and medical information for a patient-employee;
entering said demographic and medical information according to said individual employer protocol;
reporting said demographic and medical information according to said individual employer protocol;
sending said demographic and medical information to a database in a secure electronic data storage facility;
controlling access to said database to only those authorized to receive said demographic and medical information.

12. The method as defined in claim 11 wherein access to said database is granted to user selected from a group including: an employer's human resource personnel, health insurance providers, health insurance claims adjusters, health insurance claims administrators, government agencies, and monitoring organizations.

13. The method as defined in claim 11 further indicating the step of monitoring the time spent by a patient-employee at an industrial/occupational healthcare medical center.

14. The method as defined in claim 11 further including the step of monitoring the time spent by an industrial/occupational healthcare specialist with a patient-employee.
